(19) United States
(12) Patent Application Publication
(10) Pub. No.: US 2020/0231203 A1
(43) Pub. Date: Jul. 23, 2020

(54) Steering Gear and Method for Mounting a Steering Gear for a Motor Vehicle

(71) Applicant: Robert Bosch GmbH, Stuttgart (DE)

(72) Inventors: Alexander Reifschneider, Schwäbisch Gmünd (DE); Mario Gibbat, Aalen (DE); Christian Pisula, Schwäbisch Gmünd (DE); Alfred Mueller, Mutlangen (DE); Andreas Stahl, Bopfingen (DE)

(21) Appl. No.: 16/652,316

(22) PCT Filed: Sep. 24, 2018
(86) PCT No.: PCT/EP2018/075734

§ 371 Date: Mar. 30, 2020

(30) Foreign Application Priority Data
Oct. 5, 2017 (DE) 10 2017 217 652.0

(51) Int. Cl. B62D 5/04; B62D 3/12; F16H 19/04; F16H 1/16; F16H 35/10

(52) U.S. Cl. CPC B62D 5/0421; B62D 3/126; F16H 19/04; F16D 7/02; F16H 35/10; B62D 5/043; F16H 1/16

(57) ABSTRACT

In a steering gear for a motor vehicle, a bush is pressed into a concentric opening in the worm gear, wherein the steering pinion is inserted into the bush, and wherein the bush is designed to transmit a torque acting from the worm gear onto the bush onto the steering pinion. The disclosure further relates to a method for mounting a steering gear for a motor vehicle.

The invention relates to a steering gear for a motor vehicle. The invention also relates to a method for assembling a steering gear for a motor vehicle.

### PRIOR ART

In the area of steering systems, in smaller motor vehicles more and more use is being made of the variant of an electromechanical servo steering system with servo drive in the area of the steering pinion. Because of a lower number of costly parts, this variant represents the most beneficial variant of the electromechanical servo steering system.

As in most industrial products, a conflict of interests also arises here. The package, i.e. the shape and size of the installation space occupied by the steering system, represents an important criterion. Since, in the aforementioned electromechanical servo steering system, the servo drive is arranged directly on the steering pinion, said servo drive can also rotate only about the axis of said servo drive.

If the servo drive is placed at the upper end of the steering pinion, that is to say on the side of the steering shaft output, advantages result from the point of view of the assembly and the force flow. Since, here, the servo drive is seated on the upper side of the steering housing, the former is, however, located close to the foot space of the driver. Because of this aspect, a change has been made to arrange the servo drive on the underside of the steering housing. However, this results in disadvantages during the assembly and the product design. These disadvantages are primarily brought about by the fact that the worm gear, as output drive from the servo drive, cannot be preassembled with the steering pinion as hitherto; instead it has to be joined together with the steering pinion in the steering housing.

Furthermore, the steering pinion cannot be pushed through the toothing of the rack, as in other electromechanical servo steering systems, since here the flange for the worm gear is in the way.

DE 10 2011 080 979 A1 discloses a force transmission arrangement, in particular for steering assistance, comprising a rotary drive motor, a drive worm which can be driven by a rotary shaft of the drive motor, a first pinion shaft, on which a first pinion and a first worm gear are arranged, a second pinion shaft, on which a second pinion and a second worm gear are arranged, a double-toothed element having a first and a second row of teeth, which are arranged opposite one another and parallel to one another, wherein the first pinion engages in the first row of teeth and the second pinion engages in the second row of teeth, wherein the first and the second worm gear engage in the drive worm on opposite sides, wherein one of the pinion shafts is movably mounted in a direction towards the drive worm and has a force applied thereto, and wherein the rotary shaft is held between the worm gears.

The invention is thus based on the object of providing an improved steering gear and an improved method for assembling a steering gear which permit simplified assembly and improved precision of the components of the steering gear relative to one another.

The object is achieved with a steering gear for a motor vehicle having the features of patent claim 1. The object is further achieved by a method for assembling a steering gear for a motor vehicle having the features of patent claim 11.

### DISCLOSURE OF THE INVENTION

The present invention devises a steering gear for a motor vehicle having a steering gear housing and a steering pinion that can be coupled to a steering shaft, which is inserted into the steering gear housing and meshes with a rack, having a servo drive for providing a steering assist force on the steering pinion, wherein the servo drive has a worm driven by an electric motor and a worm gear which meshes with the worm, wherein a bush is pressed into a concentric opening in the worm gear, wherein the steering pinion is inserted into the bush, and wherein the bush is designed to transmit a torque from the worm gear acting on the bush onto the steering pinion.

The present invention additionally devises a method for assembling a steering gear for a motor vehicle. The method comprises assembling a preassembled subgroup by providing a worm gear and a bush, wherein the worm gear is pressed with an inner circumference onto an outer circumference of the bush, wherein a tolerance ring is arranged on the outer circumference of the bush and is designed to produce a force flow between the bush and the worm gear. The method further comprises pressing a fixed bearing for supporting a steering pinion into a steering gear housing.

The method further comprises drawing the steering pinion into the steering gear housing by means of a pulling device secured to an axial end section of the steering pinion. Moreover, the method comprises bringing toothing formed on an outer circumference of the worm gear into engagement with a worm coupled to a servo drive. The method also comprises pressing the preassembled subgroup on an inner circumference of the bush onto the steering pinion drawn into the steering gear housing.

An idea of the present invention is, because of the provision of the bush, which is pressed into the concentric of the worm gear and the steering pinion is additionally inserted into the bush, to transmit the torque from the worm gear acting on the bush onto the steering pinion. As a result of providing the bush, for example, a radial spacing between steering pinion and worm gear can be compensated. As a result of bridging the radial spacing, firstly the steering pinion can be implemented to be so slim in the area of the worm gear that the steering pinion can be mounted in a conventional way, the pinion being pushed through the toothing of the rack. Secondly, the seat of the worm gear can be implemented in such a way that the tolerance ring can be installed. In addition, the bush permits precise axial and radial positioning of the worm gear relative to the steering pinion, which in turn means that precise positioning of toothing of the worm gear, which meshes with the worm connected to the servo drive, can be achieved.

As a result, the play-free transmission of force and torque from the worm gear to the steering pinion can additionally be ensured. Furthermore, the assembly method offers the advantage that only low assembly forces are required for the assembly.

Advantageous embodiments and developments can be gathered from the subclaims and from the description, with reference to the figures.

According to a further preferred development, provision is made for the steering pinion to have a first axial end section, which can be connected to the steering shaft, and a second axial end section, at which the bush is secured to the steering pinion, wherein a spline is formed in at least some sections on an outer circumference of the steering pinion, and wherein a spline is formed on an inner circumference of the bush, which meshes with the spline of the steering pinion to transmit torque between bush and steering pinion. As a result of providing the spline on the outer circumference of the steering pinion and on the inner circumference of the bush, the steering pinion can be arranged simply and precisely in the bush and positioned relative to the latter, the respective splines permitting reliable transmission of force.

According to a further preferred development, provision is made for the bush to be designed to bridge a difference in diameter between the worm gear and the steering pinion, wherein the spline of the steering pinion is designed to transmit a torque between bush and steering pinion without play. Here, the bush can advantageously be matched to a corresponding size of the worm gear in such a way that effective compensation of a difference in diameter between the worm gear and steering pinion can be made, which means that the play-free transmission of torque between steering pinion and bush can be made possible. As a result of bridging the radial distance, firstly the steering pinion can be implemented to be so slim in the area of the worm gear that the steering pinion can be mounted in a conventional way, the pinion being pushed through the toothing of the rack. Secondly, the seat of the worm gear can be implemented in such a way that the tolerance ring can be installed.

According to a further preferred development, provision is made for freedom of play between the spline of the bush and the spline of the steering pinion to be provided by forming the spline of the steering pinion with a longitudinal convexity, wherein the spline of the bush and the spline of the steering pinion have an interference fit, and wherein the spline of the steering pinion in one of the axial end sections has a predefined angle of inclination with respect to a radial axis of the steering pinion. Providing the spline of the steering pinion with the longitudinal convexity advantageously ensures the interference fit of the splines of the steering pinion and the bush to provide the freedom of play between pinion and bush.

According to a further preferred development, provision is made for the bush to have on its outer surface a first seat to receive a slipping clutch and a second seat to receive an inner circumference of the concentric opening of the worm gear, wherein the first seat has a first diameter and the second seat has a second diameter, wherein the first diameter is smaller than the second diameter, wherein the second seat extends from a radial projection formed in a first axial end section of the bush as far as a second axial end section of the bush, and wherein the first seat is formed within the second seat in the axial direction of the bush.

The radial projection provided in the first axial end section of the bush advantageously has the effect that when the worm gear is pressed onto the bush, the radial projection acts as a stop. Furthermore, the slipping clutch is advantageously inserted into the seat having a lower diameter, by which means an effective slipping clutch between bush and worm gear can be provided in order, in the event of very high torque occurring, to provide an overload safety device for the worm gear and the components of the steering gear connected thereto.

According to a further preferred development, provision is made for the radial projection of the bush to be arranged adjacent to a fixed bearing inserted into the steering gear housing, the radial projection of the bush forming a planar stop for the worm gear pressed onto the bush. Arranging the bush adjacent to or in contact with the fixed bearing thus advantageously effects the axial securing of the bush in the steering gear housing, which means that the bush can thus advantageously provide an axial planar stop for the worm gear pressed onto the bush.

According to a further preferred development, provision is made that, between the worm gear and the bush, the slipping clutch pressed into the first seat and the bush is provided to form an overload safety device of the steering pinion, wherein the slipping clutch is formed by a tolerance ring. The slipping clutch can thus advantageously be implemented with constructionally simple means and dimensioned and formed in accordance with the corresponding requirements with respect to a maximum transmission of force from the worm gear to the steering pinion,

According to a further preferred development, provision is made for the worm gear to be positioned relative to the steering pinion by centering sections formed on the steering pinion, wherein a first centering section is arranged in front of the spline in the axial direction of the steering pinion, and a second centering section is arranged behind the spline in the axial direction of the steering pinion, and wherein the first centering section and the second centering section have the same diameter. As a result of providing the respective centering sections in front of and behind the spline, the bush, and thus likewise the worm gear pressed onto the bush, can be positioned precisely relative to the spline of the steering pinion and therefore likewise relative to the worm.

According to a further preferred development, provision is made for a thread, onto which a securing nut is screwed, to be formed on the second axial end section of the steering pinion, wherein the bush is formed as a spacer between the securing nut and the fixed bearing to secure the fixed bearing axially on the steering pinion, wherein the bush is designed to transmit an axial force that is produced during movement of the steering pinion from the fixed bearing onto the securing nut, and wherein the thread arranged on the second axial end section of the steering pinion is designed to absorb tangential and axial forces of the bush. On account of the fact that the bush rests on the fixed bearing in a first axial end section and on the securing nut in a second axial end section, a respective axial and tangential action of force on the bush can be absorbed.

According to a further preferred development, provision is made for a bearing seat of the steering pinion to have a larger diameter than a tooth tip circle of the spline of the steering pinion, and wherein a tooth tip circle diameter, preferably likewise a root tip diameter of the further toothing of the steering pinion, formed in the region of the rack, to be larger than the bearing seat of the steering pinion. As a result of forming the diameter of the steering pinion in such a way in relation to the diameter of the bearing seat of the steering pinion, it is advantageously possible to ensure that the steering pinion rests with its toothing on the bearing seat, so that the bearing seat forms an effective stop for the steering pinion in the steering gear housing. As a result of the additional axial securing of the steering pinion on the axial end section by means of the securing nut, the steering pinion can thus be fixed securely both axially and also radially in the steering gear housing.

The configurations and developments described can be combined with one another as desired.

Further possible configurations, developments and implementations of the invention also cover combinations, not explicitly mentioned, of features of the invention described previously or below with respect to the exemplary embodiments.

### BRIEF DESCRIPTION OF THE DRAWINGS

The appended drawings are intended to provide further understanding of the embodiments of the invention. They illustrate embodiments and, in conjunction with the description, serve to explain the principles and concepts of the invention.

Other embodiments and many of the advantages mentioned can be gathered in a view of the drawings. The illustrated elements of the drawings are not necessarily shown true to scale in relation to one another.

FIG. 1 shows a cross-sectional view of a steering gear for a motor vehicle according to a preferred embodiment of the invention;

FIG. 2 shows a schematic illustration of a steering pinion according to the preferred embodiment of the invention;

FIG. 3 shows a schematic illustration of a bush according to the preferred embodiment of the invention; and

FIG. 4 shows a flowchart of a method for assembling a steering gear for a motor vehicle according to the preferred embodiment of the invention.

In the figures of the drawings, the same designations designate identical or functionally identical elements, parts or components, if nothing to the contrary is indicated.

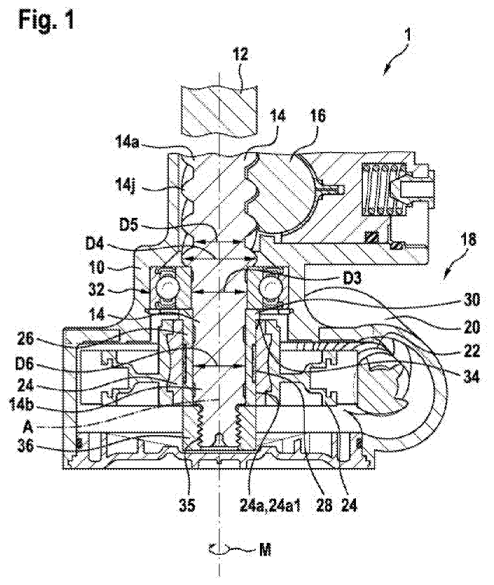

FIG. 1 shows a cross sectional view of a steering gear for a motor vehicle according to a preferred embodiment of the invention.

The steering gear 1 of the motor vehicle has a steering gear housing 10 and a steering pinion 14 that can be coupled to the steering shaft 12. The steering pinion 14 is inserted into the steering gear housing 10 and meshes with a rack 16.

The steering gear 1 further has a servo drive 18 for providing a steering assist force on the steering pinion 14. The servo drive 18 has a worm 22 driven by an electric motor 20 and a worm gear 24. The worm gear 24 meshes with the worm 22. Furthermore, the steering gear 1 has a bush 26. The bush 26 is pressed into a concentric opening 24a of the worm gear 24 in the region of an outer circumference of the bush 26. The steering pinion 14 is also inserted into the bush 26. The bush 26 is also designed to transmit a torque M from the worm gear 24 acting on the bush 26 onto the steering pinion 14.

The steering pinion 14 has a first axial end section 14a and a second axial end section 14b. The first axial end section 14a can be connected to the steering shaft 12. In the second axial end section 14b, the bush 26 is secured to the steering pinion 14. A spline 14d is formed in some sections on the outer circumference 14c of the steering pinion 14. A spline 26b is likewise formed on an inner circumference 26a of the bush 26. The spline 26b meshes with the spline 14d of the steering pinion 14 to transmit torque between bush 26 and steering pinion 14.

The bush 26 is further designed to bridge a difference in diameter between the worm gear 24 and the steering pinion 14, wherein the spline 14d of the steering pinion 14 is designed to transmit a torque between bush 26 and steering pinion 14 without play.

A radial projection 30 of the bush 26 is arranged adjacent to a fixed bearing 32 inserted into the steering gear housing 10. As a result, the radial projection 30 of the bush 26 forms a planar stop 34 for the worm gear 24 pressed onto the bush.

Between the worm gear 24 and the bush 26, a slipping clutch 28 pressed into the first seat 26d of the bush 26 is provided to form an overload safety device of the steering pinion 14. The slipping clutch 28 is preferably formed by a tolerance ring. Alternatively, the slipping clutch can be arranged in another suitable way by appropriately shaped metal plates.

A thread 35, onto which a securing nut 36 is screwed, is formed on the second axial end section 14b of the steering pinion 14. The bush is thus formed as a spacer between the securing nut 36 and the fixed bearing 32 to secure the fixed bearing 32 axially on the pinion 14. Furthermore, the bush 26 is designed to transfer an axial force of the fixed bearing 32, produced during movement of the steering pinion, onto the securing nut 36, and wherein the thread 35 arranged on the second axial end section 14b of the steering pinion 14 is designed to absorb tangential and axial forces of the bush 26.

A bearing seat 14i of the steering pinion 14 preferably has a larger diameter D3 than a tooth tip circle D6 of the spline 14d of the steering pinion 14. A tooth tip circle diameter D4, preferably likewise a root circle diameter D5, of further toothing 14j of the steering pinion 14, formed in the region of the rack 16, is preferably larger than the bearing seat 14i of the steering pinion 14.

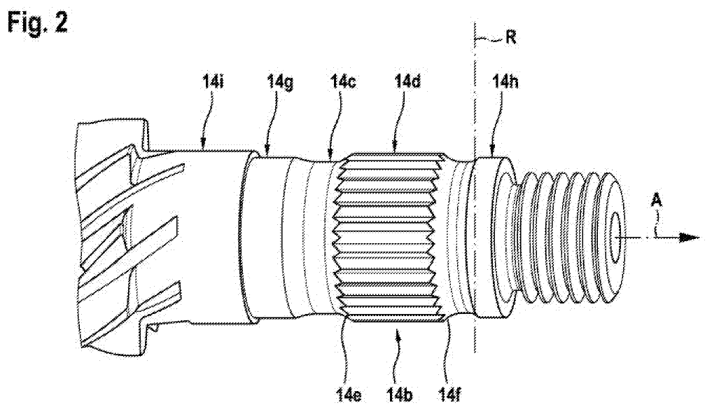

FIG. 2 shows a schematic illustration of a steering pinion according to the preferred embodiment of the invention.

Freedom of play between the spline of the bush and the spline 14d of the steering pinion 14 can advantageously be provided by forming the spine 14d of the steering pinion 14 with a longitudinal convexity. The spline of the bush and the spline 14d of the steering pinion 14 advantageously have an interference fit. The spline 14d of the steering pinion 14 also has a predefined angle of inclination with respect to a radial axis R of the steering pinion 14 in one of the axial end sections 14e, 14f.

The worm gear (not illustrated in FIG. 2) can thus be positioned relative to the steering pinion 14 by centering sections 14g, 14h formed on the steering pinion 14. A first centering section 14g is provided in front of the spline 14d in the axial direction A of the steering pinion 14, and a second centering section 14h is arranged behind the spline 14d in the axial direction A of the steering pinion 14. In addition, the first centering section 14g and the second centering section 14h have the same diameter.

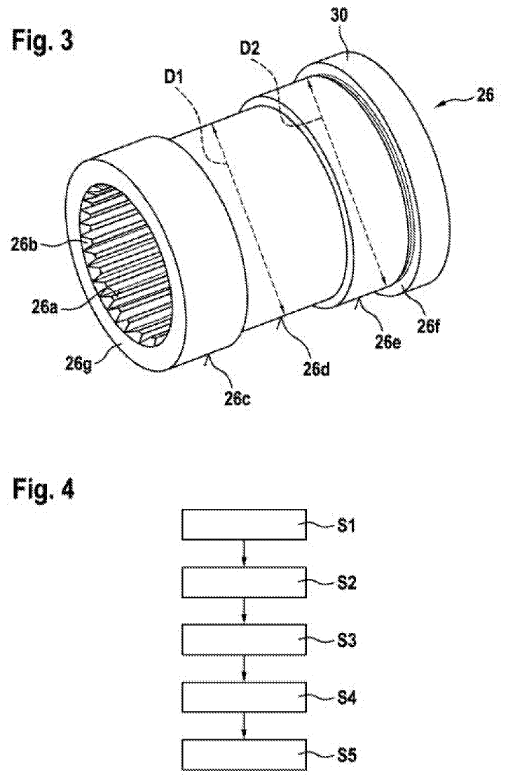

FIG. 3 shows a schematic illustration of a bush according to a preferred embodiment of the invention.

The bush 26 has on an outer surface 26c a first seat 26d to receive a slipping clutch (not shown in FIG. 3) and a second seat 26e to receive an inner circumference of the concentric opening of the worm gear (not shown in FIG. 3).

The first seat 26d has a first diameter D1, and the second seat 26e has a second diameter D2. The first diameter D1 is preferably smaller than the second diameter D2, wherein the second seat 26e extends from a radial projection formed on a first axial end section 26f of the bush 26 as far as a second axial end section 26g of the bush 26. In addition, the first seat 26d is formed within the second seat 26e in the axial direction A of the bush 26.

FIG. 4 shows a flowchart of a method for assembling a steering gear for a motor vehicle according to the preferred embodiment of the invention.

The method for assembling a steering gear for a motor vehicle comprises assembling S1 a preassembled subgroup by providing a worm gear and a bush, wherein the worm gear is pressed with an inner circumference onto an outer circumference of the bush.

The method further comprises pressing S2 a fixed bearing for supporting a steering pinion into a steering gear housing.

The method further comprises drawing S3 the steering pinion into the steering gear housing by means of a pulling device secured to an axial end section of the steering pinion.

The method moreover comprises bringing S4 toothing formed on an outer circumference of the worm gear into engagement with a worm coupled to a servo drive.

The method additionally comprises pressing S5 the pre-assembled subgroup on an inner circumference of the bush onto the steering pinion drawn into the steering gear housing.

Although the present invention has been described above by using preferred embodiments, it is not restricted thereto but rather can be modified in many ways. In particular, the invention can be changed or modified in multifarious ways without departing from the core of the invention.

For example, a shape, dimension and/or a nature of the components of the steering gear for the motor vehicle can be changed.

1. A steering gear for a motor vehicle comprising:
a steering gear housing; and
a steering pinion configured to couple to a steering shaft, which is inserted into the steering gear housing and meshes with a rack; and
a servo drive configured to provide a steering assist force on the steering pinion,
wherein the servo drive has a worm driven by an electric motor and a worm gear which meshes with the worm,
wherein a bush is pressed into a concentric opening in the worm gear,
wherein the steering pinion is inserted into the bush, and
wherein the bush is configured to transmit a torque from the worm gear acting on the bush onto the steering pinion.

2. The steering gear as claimed in claim 1, characterized in that wherein:
the steering pinion has a first axial end section configured to connect to the steering shaft, and a second axial end section, at which the bush is secured to the steering pinion,
a first spline is formed in at least some sections on an outer circumference of the steering pinion, and
a second spline is formed on an inner circumference of the bush, the second spline meshing with the first spline to transmit torque between bush and steering pinion.

3. The steering gear as claimed in claim 2, wherein the bush is configured to bridge a difference in diameter between the worm gear and the steering pinion, and the first spline is configured to transmit the torque between the bush and the steering pinion without play.

4. The steering gear as claimed in claim 2, wherein:
the first spline is formed with a longitudinal convexity so as to produce a freedom of play between the second spline and the first spline,
the second spline and the first spline have an interference fit, and
the first spline has, in axial end sections, a predefined angle of inclination with respect to a radial axis of the steering pinion.

5. The steering gear as claimed in claim 1, wherein:
the bush has an outer surface with a first seat configured to receive a slipping clutch and a second seat configured to receive an inner circumference of the concentric opening of the worm gear,
the first seat has a first diameter and the second seat has a second diameter, the first diameter being smaller than the second diameter,
the second seat extends from a radial projection formed in a first axial end section of the bush as far as to a second axial end section of the bush, and
the first seat is formed within the second seat in an axial direction of the bush.

6. The steering gear as claimed in claim 5, wherein the radial projection of the bush is arranged adjacent to a fixed bearing inserted into the steering gear housing, the radial projection of the bush forming a planar stop for the worm gear pressed onto the bush.

7. The steering gear as claimed in claim 5, wherein, the slipping clutch pressed into the first seat of the bush is provided to form an overload safety device of the worm gear between the worm gear and the bush, the slipping clutch being formed by a tolerance ring.

8. The steering gear as claimed in claim 2, wherein:
the worm gear is positioned relative to the steering pinion by first and second centering sections formed on the steering pinion,
the first centering section is arranged in front of the first spline in an axial direction of the steering pinion and the second centering section is arranged behind the first spline in the axial direction, and
the first centering section and the second centering section have the same diameter.

9. The steering gear as claimed in claim 8, wherein:
a thread, onto which a securing nut is screwed, is formed on the second axial end section of the steering pinion,
the bush is formed as a spacer between the securing nut and the fixed bearing to secure the fixed bearing axially on the steering pinion,
the bush is configured to transmit an axial force that is produced during movement of the steering pinion from the fixed bearing onto the securing nut, and
the thread arranged on the second axial end section of the steering pinion is configured to absorb tangential and axial forces of the bush.

10. The steering gear as claimed in claim 2, wherein:
a bearing seat of the steering pinion has a larger diameter than a tooth tip circle of the first spline of the steering pinion, and wherein
a tooth tip circle diameter formed in the region of the rack is larger than the bearing seat of the steering pinion.

11. A method for assembling a steering gear for a motor vehicle, comprising:
assembling a preassembled subgroup by pressing a worm gear with an inner circumference onto an outer circumference of a bush;
pressing a fixed bearing for supporting a steering pinion into a steering gear housing;
drawing the steering pinion into the steering gear housing with a pulling device secured to an axial end section of the steering pinion;
bringing toothing formed on an outer circumference of the worm gear into engagement with a worm coupled to a servo drive; and
pressing the pre-assembled subgroup on an inner circumference of the bush onto the steering pinion drawn into the steering gear housing.

12. The steering gear as claimed in claim 10, wherein a root tip diameter of further toothing of the steering pinion is larger than the bearing seat of the steering pinion
